(19) United States
(12) Patent Application Publication
(10) Pub. No.: US 2018/0283318 A1
(43) Pub. Date: Oct. 4, 2018

(54) BEARING INSTALLATION SYSTEM AND METHOD

(71) Applicant: Honda Motor Co., Ltd., Tokyo (JP)

(72) Inventors: Kristopher Ryann LELLIOTT, Barrie (CA); Hao Rong ZHENG, Toronto (CA); David NAUGHTON, Coldwater (CA); Yens C. THALENHORST, Shelburne (CA)

(21) Appl. No.: 15/475,837

(22) Filed: Mar. 31, 2017

(51) Int. Cl. F02F 7/00; B23P 15/00

(52) U.S. Cl. CPC F02F 7/0053; F02F 2200/00; B23P 2700/07; B23P 15/003

(57) ABSTRACT

A system and method for installing a predetermined number of bearings into a lower block of an engine includes a tray having a plurality of slots for receiving the predetermined number of bearings, a plurality of proximity sensors, each of the proximity sensors associated with one of the slots in the tray for tracking the predetermined number of bearings, a visual indicator for confirming movement of the predetermined number of bearings into and out of the tray, and a light curtain for sounding an alarm if the lower block is moved to an installation position for installation to the engine block before the movement of the predetermined number of bearings into and out of the tray is completed to ensure all of the predetermined number of bearings are installed in the lower block.

### TECHNICAL FIELD

The embodiments disclosed herein are related to a system and method of assembling a component part of a motor vehicle.

### BACKGROUND

An engine block includes an upper block and a lower block. Placed between the upper block and the lower block is a crankshaft that rotates within the assembled engine block. Upper main bearings that rest between the crankshaft and the upper block and lower main bearings that rest between the crankshaft and the lower block aid in rotation of the crankshaft. Failure to install the lower main bearings in the lower block properly during the assembly process may negatively impact performance of the engine. Therefore, there exists a need for a system and method to ensure proper installation of the lower main bearings in the lower block prior to assembly of the engine block.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a system for installing a predetermined number of parts into a component includes a tray having a plurality of sections for receiving the predetermined number of parts, a plurality of proximity sensors, each of the proximity sensors associated with one of the sections in the tray for tracking the predetermined number of parts, a visual indicator for confirming movement of the predetermined number of parts into and out of the tray, and a light curtain for sounding an alarm if the component is moved to an installation position before the movement of the predetermined number of parts into and out of the tray is completed.

According to another aspect, a system for installing a predetermined number of bearings into a lower block of an engine includes a tray having a plurality of slots for receiving the predetermined number of bearings, a plurality of proximity sensors, each of the proximity sensors associated with one of the slots in the tray for tracking the predetermined number of bearings, a visual indicator for confirming movement of the predetermined number of bearings into and out of the tray, and a light curtain for sounding an alarm if the lower block is moved to an installation position for installation in the engine before the movement of the predetermined number of bearings into and out of the tray is completed to ensure all of the predetermined number of bearings are installed in the lower block.

According to yet another aspect, a method for installing a predetermined number of parts into a component includes the steps of providing a tray having a plurality of sections for receiving the predetermined number of parts, placing the predetermined number of parts into the sections of the tray, detecting the presence of the predetermined number of parts with a plurality of proximity sensors, each of the proximity sensors associated with one of the sections in the tray for tracking the predetermined number of parts, installing each of the predetermined number of parts into the component, and providing a visual indicator for confirming movement of the predetermined number of parts out of the tray.

### BRIEF DESCRIPTION OF THE DRAWINGS

FIG. 1 is an exploded view of an engine block assembled by the system and method disclosed herein.

FIG. 2 is a perspective view of a crankshaft installed in the engine block of FIG. 1.

FIG. 3 is a perspective view of upper and lower main bearings installed in the engine block of FIG. 1.

FIG. 4 is a top perspective view of a lower main bearing assembly tray.

FIG. 5 is a top perspective view of the lower main bearing assembly tray holding lower main bearings.

FIG. 6 is a perspective view of a proximity sensor.

FIG. 7 is an illustration of an embodiment of a visual indicator.

FIG. 8 is a side perspective view of the lower main bearing assembly tray.

FIG. 9 is a top plan view of an assembly work station.

FIG. 10 is a flowchart showing a method of assembling the engine block of FIG. 1.

The FIGS. depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

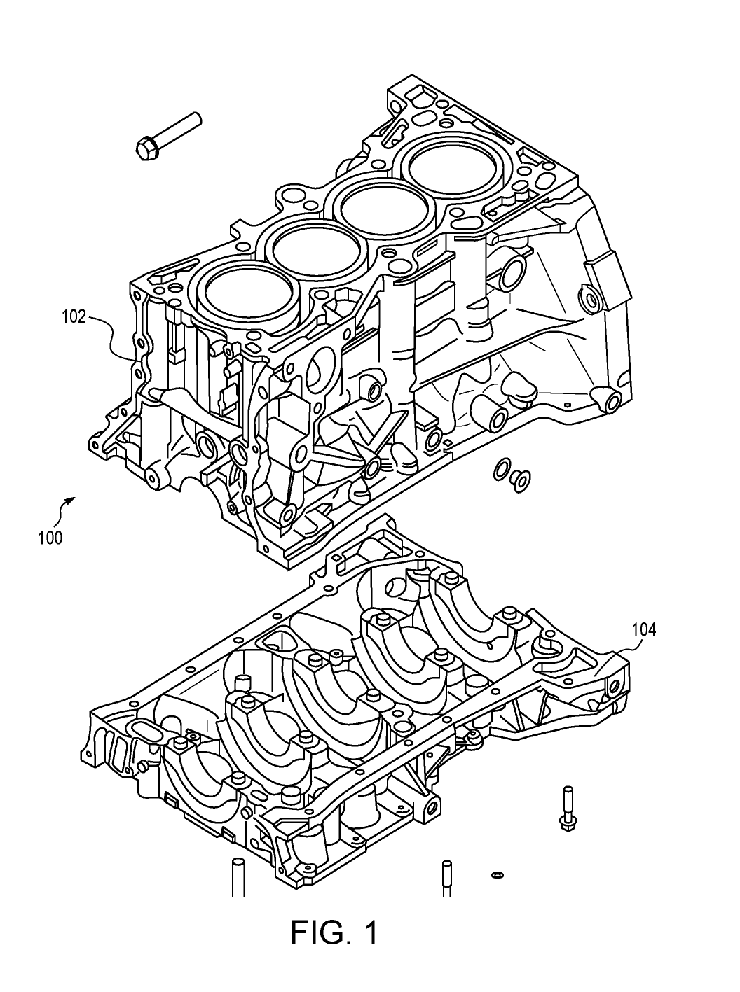

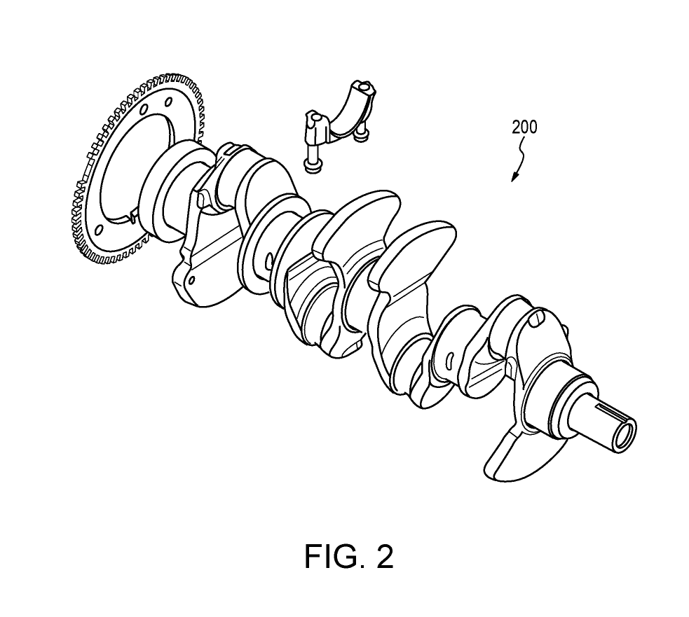

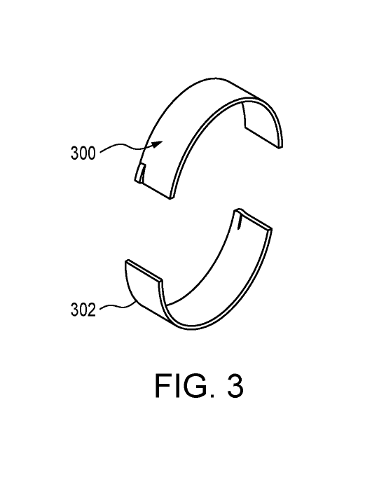

FIG. 1 is an exploded view illustration of an engine block 100 for a motor vehicle. The engine block 100 includes an upper block 102 and a lower block 104. Placed between the upper block 102 and the lower block 104 is a crankshaft 200, illustrated in FIG. 2. The crankshaft 200 rotates within the assembled engine block 100 with the aid of upper main bearings 300, illustrated in FIG. 3, that rest between the crankshaft 200 and the upper block 102 and lower main bearings 302 that rest between the crankshaft 200 and the lower block 104.

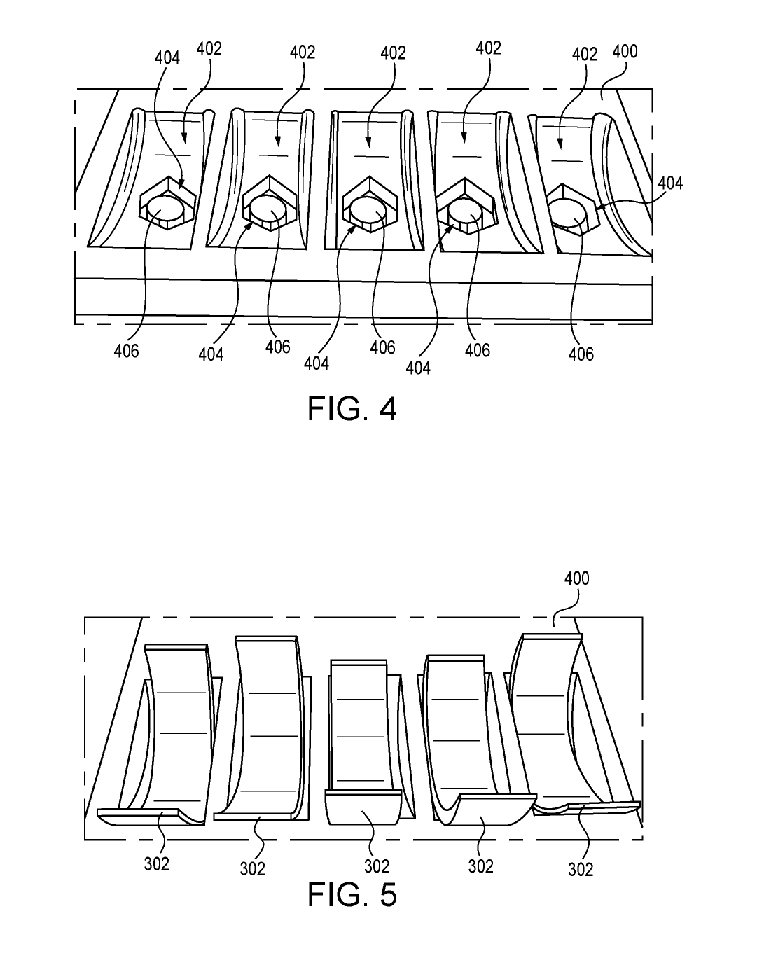

With further reference to FIGS. 4-9, an embodiment of a system and method for assembling the lower main bearings 302 into the lower block 104 prior to assembly of the lower block 104, crankshaft 200, and upper block 102 to form the assembled engine block 100 is disclosed.

FIGS. 4-5 illustrate a tray 400 that is provided for holding the lower main bearings 302 prior to installation in the lower block 104, with FIG. 4 illustrating the tray 400 without the lower main bearings 302, and FIG. 5 showing the tray 400 holding the lower main bearings 302. The tray 400 includes a predetermined number of slots 402 that is preferably equal to the number of lower main bearings 302 to be installed in the lower block 104. In the embodiment illustrated in FIG. 4, the tray 400 includes five (5) slots 402. The slots 402 are shaped to receive the semi-circular shaped lower main bearings 302.

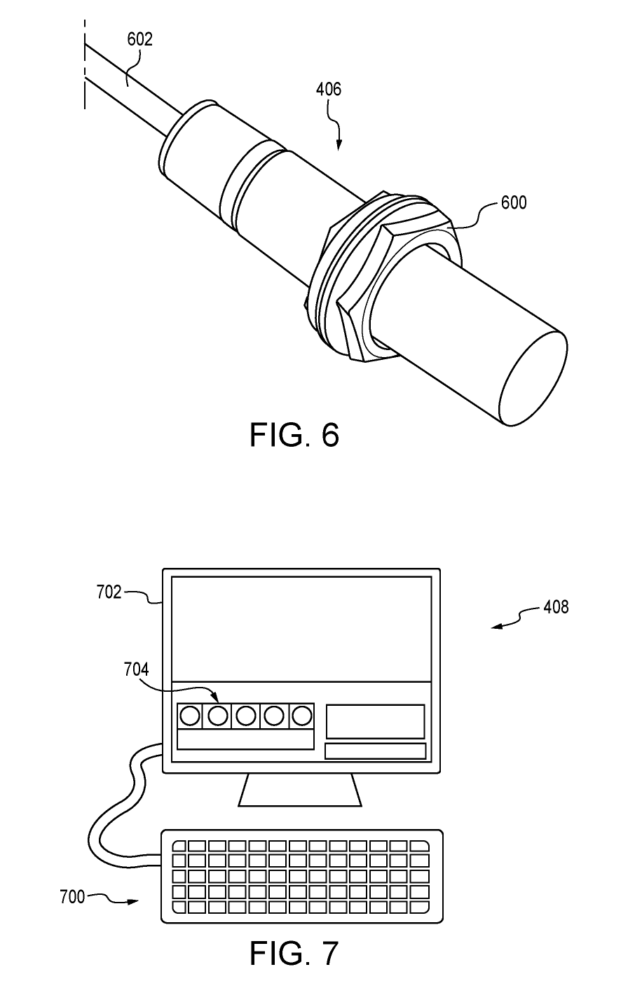

Each of the slots 402 further includes a hole 404 which is sized to receive a proximity sensor 406 which detects whether a lower main bearing 302 is present in the slot 402. The proximity sensor 406 may be an inductive proximity sensor that operates under the electrical principle of inductance that is well known to those skilled in the art. An inductive-type proximity sensor 406, illustrated in FIG. 6, may be used because the lower main bearings 302 are constructed from a ferrous material that may magnetically alter currents with the proximity sensor when present.

As illustrated in FIG. 7, a visual indicator 408 includes a processor that monitors each of the proximity sensors 406 and a display for visually displaying indicia to the assembly worker. The visual indicator 408 may indicate the presence or absence of lower main bearings 302 in each of the slots 402. The processor may be a simple ECU or, as illustrated in FIG. 7, a general-purpose computer 700 known to those skilled in the art. The display may be a monitor 702 showing a visual depiction 704 of the tray 400 with a number indicating each slot 402 and the presence or absence of a lower main bearing 302 in each slot 402. In an alternative embodiment not shown, the display may be an analog display of lights corresponding to the presence or absence of a lower main bearing 302 in each slot 402 or any other suitable system or method for providing a visual display to an assembly worker responsible for the installation of the lower main bearings 302 into lower block 104.

The proximity sensors 406 are inserted into the holes 404 of each of the slots 402 from beneath the tray 400. Each of the holes 404 may have an angular shape to receive more securely a nut 600 on proximity sensor 406. In the illustrated embodiment in FIGS. 4 and 6, the nut 600 is a standard hexagonal shape, as is the hole 404 in which the nut 600 of the proximity sensor 406 is received. The angular shape of the hole 404, which coincides with the shape of the nut 600 on the proximity sensor 406, prevents movement of the proximity sensors 406 in the tray 400. Therefore, reliability and quality of the system is maintained.

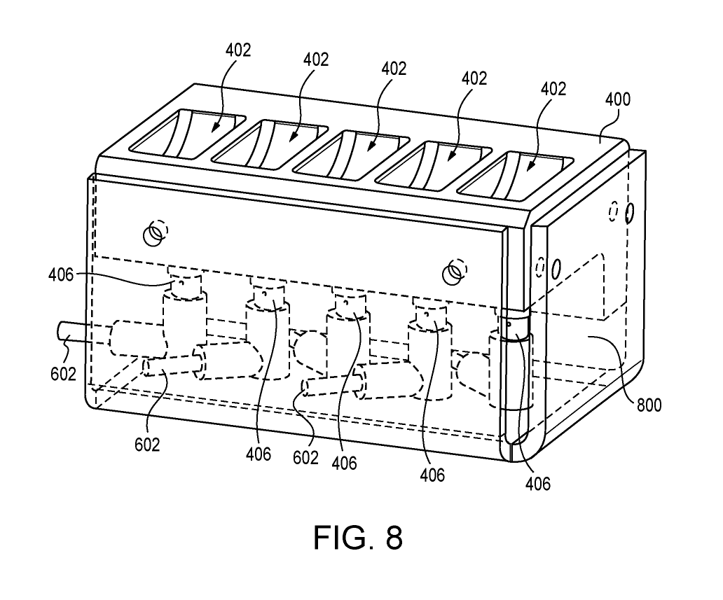

Due to the presence of the proximity sensors 406 beneath the tray 400, along with the wires 602 that provide the electrical communication with the visual indicator 408, there is also a need to provide a cover 800, as illustrated in FIG. 8, around the bottom of the tray 400. In order to aid in maintenance of the system, the cover 800 may be constructed of a transparent polycarbonate thermoplastic, such as those sold under the tradenames including Lexan, Makrolon, Hammerglass and others.

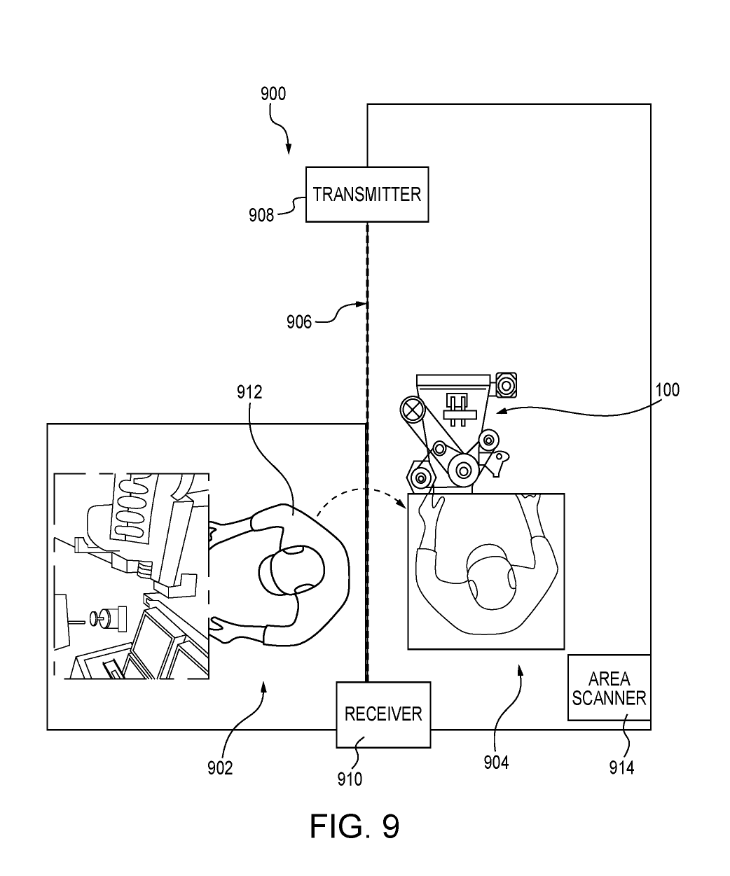

As illustrated in FIG. 9, the tray 400 is located in a loading zone 902 of an engine assembly workstation 900. The lower main bearings 302 are installed in the lower block 104 in the loading zone 902. The engine assembly workstation 900 further includes an installation zone 904 to where the lower block 104 is transferred after the lower main bearings 302 are installed for assembly of the lower block 104 to the engine block 100. The loading zone 902 and the installation zone 904 are separated by a presence detection device such as a light curtain 906. A light curtain may typically include a transmitter 908 and receiver 910. The transmitter 908 projects an array of parallel infrared light beams to the receiver 910 which consists of a number of photoelectric cells. When an assembly worker 912 moves between the loading zone 902 and the installation zone 904, the worker breaks one or more of the beams and change in location is communicated to the processor in the visual indicator 408.

While the presence detection device is described as a light curtain 906 in the illustrated embodiment, other presence detection devices may also be used, such as an area scanner 914 like an optical scanners or laser scanners, or a pressure sensitive floor sensor or any other suitable method known to those skilled in the art.

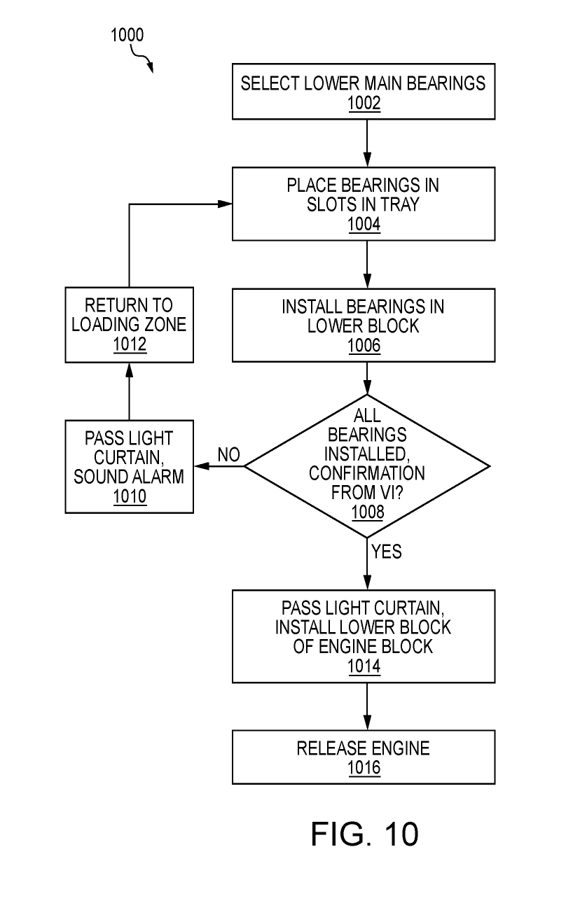

A method 1000 of installing the lower main bearings 302 is now disclosed that is illustrated in the flowchart in FIG. 10. In the first step 1002, the correct lower main bearings 302 to be installed are selected and input into the visual indicator 408. In the second step 1004, the correct number of lower main bearings 302 to be installed in the lower block 104 are placed in the slots 402 of the tray 400. The proximity sensors 406 detect that the lower main bearings 302 are placed into the tray 400, and the visual indicator 408 indicates to the assembly worker that all the lower main bearings 302 are present.

In the third step 1006, all of the lower main bearings 302 in the tray 400 are installed in the lower block 104. In step four 1008, if all of the lower main bearings 302 are removed from the tray 400, the visual indicator gives an install confirmation. If all of the lower main bearings 302 are not removed from the tray 400, an alternate step 1010 occurs, and if the assembly worker moves the lower block to the installation zone 904 through the light curtain 906, a fault occurs and an alarm will sound.

As shown in step 1012, to clear the fault, the lower block must be returned to the loading zone 902, and the method resets to step 1004 such that all of the lower main bearings 302 must be reloaded in the tray 400, and the third step 1006 is repeated. In the event that the fault is not cleared, and the method is not followed, the assembled engine block 100 may be flagged for further review.

In the case where all of the lower main bearings 302 are installed, and the visual indicator 408 indicates all of the lower main bearings 302 are out of the slots 402 in the tray 400, the assembly worker 912 may move on to step 1014 and pass through the light curtain 906 and assemble the lower block 104 to the engine block 100. Finally, in step 1016, the engine block 100 may be released to move on in the production cycle.

The system and method 1000 disclosed herein have been directed to the assembly of lower main bearings 302 into the lower block 104 of an engine block 100 for an engine for a motor vehicle. The system and method 1000, however, may be applied to any circumstance that requires the assembly of a predetermined number of parts into a component in a factory, and the embodiment illustrating the assembly of an engine block is merely illustrative.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A system for installing a predetermined number of parts into a component, comprising:
a tray having a plurality of sections for receiving the predetermined number of parts;
a plurality of proximity sensors, each of the proximity sensors associated with one of the sections in the tray for tracking the predetermined number of parts;
a visual indicator for confirming movement of the predetermined number of parts into and out of the tray; and
a light curtain for sounding an alarm if the component is moved to an installation position before the movement of the predetermined number of parts into and out of the tray is completed.

2. The system of claim 1 wherein the tray further comprises:
a plurality of holes, each one of the holes located within one of the sections, each of the plurality of proximity sensors disposed in one of the holes.

3. The system of claim 2 wherein the holes have an angular shape.

4. The system of claim 3 further comprising:
a removable cover attached to the tray for covering the proximity sensors disposed in the holes in the tray.

5. The system of claim 4 wherein the removable cover is transparent.

6. The system of claim 5 wherein the angular shape is hexagonal.

7. The system of claim 1 wherein the visual indicator is a monitor.

8. A system for installing a predetermined number of bearings into a lower block of an engine, comprising:
a tray having a plurality of slots for receiving the predetermined number of bearings;
a plurality of proximity sensors, each of the proximity sensors associated with one of the slots in the tray for tracking the predetermined number of bearings;
a visual indicator for confirming movement of the predetermined number of bearings into and out of the tray; and
a light curtain for sounding an alarm if the lower block is moved to an installation position for installation in the engine before the movement of the predetermined number of bearings into and out of the tray is completed to ensure all of the predetermined number of bearings are installed in the lower block.

9. The system of claim 8 wherein the tray further comprises:
a plurality of holes, each one of the holes located within one of the slots, each of the plurality of proximity sensors disposed in one of the holes.

10. The system of claim 9 wherein the holes have an angular shape.

11. The system of claim 10 further comprising:
a removable cover attached to the tray for covering the proximity sensors disposed in the holes in the tray.

12. The system of claim 11 wherein the removable cover is transparent.

13. The system of claim 12 wherein the removable cover is made of a polycarbonate thermoplastic.

14. The system of claim 13 wherein the angular shape is hexagonal.

15. The system of claim 8 wherein the visual indicator is a monitor.

16. A method for installing a predetermined number of parts into a component, comprising the steps of:
providing a tray having a plurality of sections for receiving the predetermined number of parts;
placing the predetermined number of parts into the sections of the tray;
detecting the presence of the predetermined number of parts with a plurality of proximity sensors, each of the proximity sensors associated with one of the sections in the tray for tracking the predetermined number of parts;
installing each of the predetermined number of parts into the component; and
providing a visual indicator for confirming movement of the predetermined number of parts into and out of the tray.

17. The method of claim 16 further comprising the step of:
providing a light curtain for sounding an alarm if the component is moved to an installation position before the movement of the predetermined number of parts into and out of the tray is completed.

18. The method of claim 17 further comprising the step of:
visually inspecting the plurality of proximity sensors.

19. The method of claim 18 further comprising the step of:
performing maintenance on the tray.

20. The method of claim 16 wherein the step of providing a visual indicator further comprises the step of:
providing indicia on a monitor.
